(19) United States
(12) Patent Application Publication
(10) Pub. No.: US 2021/0176966 A1
(43) Pub. Date: Jun. 17, 2021

(54) FITTING IMPLEMENT AND FITTING METHOD

(71) Applicant: Sharp Kabushiki Kaisha, Sakai City, Osaka (JP)

(72) Inventors: Azusa NAKANO, Sakai City (JP); Hiroshi SAKAYA, Sakai City (JP); Tetsuya HAYASHI, Sakai City (JP)

(21) Appl. No.: 16/636,349

(22) PCT Filed: Jul. 26, 2018
(86) PCT No.: PCT/JP2018/028115

§ 371 Date: Feb. 4, 2020

(30) Foreign Application Priority Data
Aug. 8, 2017 (JP) 2017-153661

(51) Int. Cl. A01K 27/00; A01K 29/00

(52) U.S. Cl. CPC A01K 27/002; A01K 27/008; A01K 29/005; A01K 27/001

(57) ABSTRACT

The present disclosure provides, for example, a fitting implement that reduces stress on an animal. A fitting implement is to be worn by an animal and includes: a collar section to be fitted around a neck of the animal; and a first belt section and a second belt section each having an end connected to the collar section, wherein the first and second belt sections each include, at another end thereof, a connecting section configured to connect the other ends together.

### TECHNICAL FIELD

The present disclosure relates to a fitting implement worn by a living organism, especially by an animal with body hair, and relates also to a method of attaching such a fitting implement to an animal.

### BACKGROUND ART

Patent Literature 1 discloses a device for detecting biosignals of an animal, the device including a harness-like fitting member including: a chest strap; and a collar member. In the fitting member, the chest strap includes an upper strap piece to be passed from side to side over the back to cover the chest and a lower strap piece to be passed from side to side under the lower chest to cover the lower chest. The chest strap forms a circle when the upper and lower strap pieces are connected together at their ends. The upper strap piece has a columnar elastic member and an electrode on the inner surface of each end thereof. The electrode straddles the elastic member and extends toward the lengthwise middle of the upper strap piece. The electrode is passed through a slit formed in the upper strap piece to extend from the inner face to the outer face of the upper strap piece. The electrode is then disposed, at the far end thereof, on an insulating coating sheet on the outer face of the upper strap piece. An output means is removably attached to the electrode via a fixing member.

### CITATION LIST

### Patent Literature

Patent Literature 1: Japanese Patent Publication No. 3978453 (issued on Sep. 19, 2007)

### SUMMARY

### Technical Problem

In the fitting member disclosed in Patent Literature 1, however, the chest strap may be displaced as a result of a motion of the animal. The collar member can be pulled toward the back of the animal, possibly constricting its neck.

The present disclosure, in an aspect thereof, has an object to provide, for example, a fitting implement that reduces stress on the animal.

### Solution to Problem

To address this issue, the present disclosure, in an aspect thereof, is directed to a fitting implement to be worn by an animal, the fitting implement including: a collar section to be fitted around a neck of the animal; and a first belt section and a second belt section each having an end connected to the collar section, wherein the first and second belt sections each include, at another end thereof, a connecting section configured to connect the other ends together.

The present disclosure, in another aspect thereof, is directed to a fitting implement to be worn by an animal, the fitting implement including: a collar section to be fitted around a neck of the animal; and a belt section having an end connected to the collar section, wherein the belt section includes, at another end thereof, a connecting section configured to connect the other end to the collar section, and the belt section has a suitable length to come into contact with respective left and right axillae of the animal for fitting.

### Advantageous Effects of Disclosure

The present disclosure, in an aspect thereof, provides a fitting implement that reduces stress on the animal.

### BRIEF DESCRIPTION OF DRAWINGS

Portion (a) of FIG. 1 is a perspective view of an exemplary structure of a fitting implement in accordance with Embodiment 1, and (b) of FIG. 1 is a perspective view of another exemplary structure of the fitting implement in accordance with Embodiment 1.

Portion (a) of FIG. 2 is a front view of a holder section before the holder section holds a coupler section, (b) of FIG. 2 is a side view of the holder in the same condition as in (a) of FIG. 2, and (c) of FIG. 2 is a side view of the holder section holding the coupler section.

FIG. 3 is a set of illustrations of a method of fitting the fitting implement in accordance with Embodiment 1 to a dog, (a) of FIG. 3 showing the fitting implement being fitted to a dog and (b) of FIG. 3 showing the fitting implement having been fitted completely.

FIG. 4 is a perspective view of a structure of a fitting implement in accordance with a variation example of Embodiment 1.

FIG. 5 is a perspective view of a structure of a fitting implement in accordance with a variation example of Embodiment 1 other than the variation example shown in FIG. 4.

FIG. 6 is a perspective view of a structure of a fitting implement in accordance with Embodiment 2.

Portion (a) of FIG. 7 is a front view of a cover section 62 of a casing with the cover section 62 being open, (b) of FIG. 7 is a side view of the cover section 62 in the same condition as in (a) of FIG. 7, and (c) of FIG. 7 is a side view of the cover section 62 which is now closed.

Portion (a) of FIG. 8 is an illustration of an exemplary shape of a bag section, and (b) of FIG. 8 is an illustration of an exemplary shape of the bag section other than the example shown in (a) of FIG. 8.

Portion (a) of FIG. 9 is an illustration of an exemplary method of disposing a conductive wire in a collar section, (b) of FIG. 9 is an illustration of an exemplary method of disposing a conductive wire in a collar section other than the example shown in (a) of FIG. 9, and (c) of FIG. 9 is an illustration of an exemplary method of disposing a conductive wire in a collar section other than the examples shown in (a) and (b) of FIG. 9.

Portion (a) of FIG. 10 is a backside view of an exemplary method of connecting electrodes to a measuring instrument, (b) of FIG. 10 is a backside view of an exemplary method of connecting electrodes to a measuring instrument other than the example shown in (a) of FIG. 10, (c) of FIG. 10 is an illustration of another exemplary strap member, (d) of FIG. 10 is an illustration of a variation example of the exemplary method of connecting electrodes to a measuring instrument shown in (b) of FIG. 10, and (e) of FIG. 10 is an illustration of another exemplary method of connecting electrodes to a measuring instrument.

Portion (a) of FIG. 11 is a perspective view of a casing with a cover section including a fixing member, and (b) of FIG. 11 is a cross-sectional view of the casing shown in (a) of FIG. 11 with the cover section being closed, as viewed from a side of the casing.

Portion (a) of FIG. 12 is a perspective view of a casing with a bag section including a fixing member, (b) of FIG. 12 is a perspective view of the casing shown in (a) of FIG. 12 with the cover section being closed, and (c) of FIG. 12 is a cross-sectional view of the casing in the same condition as in (b) of FIG. 12, as viewed from a side of the casing.

FIG. 13 is a set of illustrations of a structure of a portion of a fitting implement in accordance with Embodiment 3, (a) of FIG. 13 being a front view and (b) of FIG. 13 being a backside view.

Portion (a) of FIG. 14 is a bottom view of a temperature sensor showing its shape, (b) of FIG. 14 is a side view of the temperature sensor showing its shape, (c) of FIG. 14 is an illustration of an exemplary method of fixing the temperature sensor in the location of a hole, and (d) of FIG. 14 is an illustration of an exemplary method of fixing the temperature sensor in the location of a hole other than the example shown in (c) of FIG. 14.

### DESCRIPTION OF EMBODIMENTS

The following will describe examples where the animal by which the fitting implement is worn is a dog. The animal by which the fitting implement is worn is not necessarily a dog and may be, for example, (i) a companion animal such as a cat, a rabbit, a ferret, a monkey, or a hamster, (ii) a farm animal such as a horse, a cow, a pig, a sheep, or a goat, or (iii) a large-sized animal such as a tiger or a lion.

### Embodiment 1

A description is now given of an embodiment of the present disclosure with reference to FIGS. 1 to 5.

Portion (a) of FIG. 1 is a perspective view of an exemplary structure of a harness 100 in accordance with the present embodiment. The harness 100 includes a leash 90 and a fitting implement 1. The fitting implement 1 includes a collar section 10, a first belt section 21, and a second belt section 22 as shown in (a) of FIG. 1. The leash 90 is attached to the collar section 10.

Portion (b) of FIG. 1 is a perspective view of another exemplary structure of the harness 100 in accordance with the present embodiment. In the harness 100, the leash 90 may be removable from the collar section 10. For instance, the harness 100 may include a leash-end belt 91 to which the leash 90 is attached as shown in (b) of FIG. 1, in which case there may be provided connecting members 91a to 91d on the collar section 10 and the leash-end belt 91 to connect the leash-end belt 91 to the collar section 10.

The collar section 10 is collar fitted around the neck of a dog. Referring to (a) of FIG. 1, the collar section 10 includes a strap-shaped main segment 11 having a coupler section 12 on each end thereof. The collar section 10 takes on an annular shape when coupling these ends via the coupler sections 12. The collar section 10 however does not necessarily have the coupler sections 12 and may alternatively be provided in the form of a continuous, annular member.

The collar section 10 is not necessarily made of a particular material and may be made of any material including natural leather, synthetic leather, resin, natural fiber, and chemical fiber. The collar section 10 may further include an adjuster section (not shown) to allow for adjustment of the length thereof.

The first belt section 21 and the second belt section 22 are belts each having a first end connected to the collar section 10. The first belt section 21 and the second belt section 22 each have a second end where there is provided a connecting section 23 to connect the first belt section 21 and the second belt section 22 together at these second ends. When the dog is in the fitting implement 1, the first belt section 21 and the second belt section 22 are passed under the dog's left and right armpits respectively.

The connecting sections 23 include a first connecting member 231 and a second connecting member 232 disposed at the respective second ends of the first belt section 21 and the second belt section 22. Examples of the first connecting member 231 and the second connecting member 232 include buckles, hooks, press studs, and buttons. The first belt section 21 and the second belt section 22, together with a portion of the collar section 10, form an annular belt when the first connecting member 231 and the second connecting member 232 are connected. The first connecting member 231 and the second connecting member 232, in the present embodiment, are connected to each other on the dog's back. Alternatively, the first belt section 21 and the second belt section 22 may have different lengths so that the first connecting member 231 and the second connecting member 232 can be connected, for example, on the dog's abdomen or side abdomen, other than on the dog's back.

The first connecting member 231 and the second connecting member 232 also function to adjust the lengths of the first belt section 21 and the second belt section 22 respectively. The lengths of the first belt section 21 and the second belt section 22 can be adjusted by folding back the first belt section 21 and the second belt section 22 at the first connecting member 231 and the second connecting member 232 respectively.

The first belt section 21 and the second belt section 22 are partly or entirely made of, for example, rubber or another elastic material. For instance, the first belt section 21 and the second belt section 22 may be provided by connecting a rubber belt with a poorly or hardly stretchable belt.

The first belt section 21 and the second belt section 22 include respective contact sections 24 and 25. When the dog is in the fitting implement 1, the contact sections 24 and 25 are in contact with the dog's left and right axillae respectively. The contact sections 24 and 25 may be, for instance, cylindrical cushioning members (e.g., polychloroprene) positioned respectively where the first belt section 21 and the second belt section 22 come in contact with the dog's axillae. The contact sections 24 and 25 are not necessarily provided separately from the main segments of the first belt section 21 and the second belt section 22.

The first belt section 21 and the second belt section 22 are at least partly elastic as described above. This elasticity of the first belt section 21 and the second belt section 22 maintains the contact sections 24 and 25 in contact with the dog's axillae even when the dog wearing the fitting implement 1 changes its posture.

The collar section 10 includes a holder section 30. The holder section 30 restricts displacement of the interconnected first and second belt sections 21 and 22 relative to the collar section 10. The holder section 30 of the present embodiment includes an upper piece 31 (first opposing section, first piece of cloth) and a lower piece 32 (second opposing section, second piece of cloth).

The collar section 10 includes two circumferential segments delimited by the locations of the connections of the first and second belt sections 21 and 22 to the collar section 10. The upper piece 31 constitutes a part of a longer one of the circumferential segments, which is described here taking (a) of FIG. 1 as an example. The collar section 10 includes two circumferential segments 10a and 10b divided at the locations of the connections of the first and second belt sections 21 and 22 to the collar section 10. The longer one of the circumferential segments is the circumferential segment 10a, not the circumferential segment 10b where the coupler sections 12 are disposed. If the collar section 10 is formed by rendering the strap-shaped main segment 11 annular, the upper piece 31 may be disposed on the annular main segment 11 which is the collar section. In such a case, the upper piece 31 is disposed on the circumferential segment 10a, which is the longer one of the two circumferential segments 10a and 10b divided at the two locations of the connections of the first and second belt sections 21 and 22 to the annular main segment 11. Meanwhile, the lower piece 32 is disposed on the upper piece 31 or on the circumferential segment 10a of the collar section 10 where the upper piece 31 is disposed.

In the present embodiment, the upper piece 31 and the lower piece 32 can sandwich the connecting sections 23. In so doing, the upper piece 31 and the lower piece 32 also sandwich the first belt section 21 and the second belt section 22 extending from the connecting sections 23. The upper piece 31 and the lower piece 32 may sandwich, for example, at least one of the first belt section 21 and the second belt section 22. By sandwiching at least one of the first belt section 21 and the second belt section 22, the upper piece 31 and the lower piece 32 can restrict displacement of the first belt section 21 and the second belt section 22 relative to the collar section 10.

Portion (a) of FIG. 2 is a front view of the upper piece 31 and the lower piece 32 before the upper piece 31 and the lower piece 32 sandwich the connecting sections 23. Portion (b) of FIG. 2 is a side view of the upper piece 31 and the lower piece 32 in the same condition as in (a) of FIG. 2. Portion (c) of FIG. 2 is a side view of the upper piece 31 and the lower piece 32 sandwiching the connecting sections 23.

The upper piece 31 and the lower piece 32 include hook and loop fasteners 33 and 34 respectively on their opposing faces. To hold the connecting sections 23 in the holder section 30, the connecting sections 23 are placed on the lower piece 32 with the upper piece 31 and the lower piece 32 being open, as shown in (a) and (b) of FIG. 2. Sandwiching the connecting sections 23 between the upper piece 31 and the lower piece 32 in this condition as shown in (c) of FIG. 2 results in the hook and loop fasteners 33 and 34 engaging with each other sandwiching the connecting sections 23 therebetween.

The holder section 30 is thus capable of holding the first belt section 21 and the second belt section 22 in suitable locations. The holder section 30 hence reduces the stress on the dog caused by the displacement of the first belt section 21 and the second belt section 22 from their suitable locations. The covering of the connecting sections 23 by the holder section 30 can also reduce the possibility of, for example, the connecting sections 23 coming into contact with, and abrading, the dog's skin. The covering of the connecting sections 23 by the holder section 30 also improves appearance.

The connecting sections 23 may be held anywhere in the holder section 30 as long as the connecting sections 23 remain within the engaging surfaces of the hook and loop fasteners 33 and 34. Therefore, the stress on the dog of wearing the fitting implement 1 can be reduced by determining the locations of the connecting sections 23 according to the dog's body size. The hook and loop fasteners 33 and 34 preferably have large areas to provide extra freedom in positioning the connecting sections 23 in the holder section 30.

Referring to (a) of FIG. 2, the holder section 30 can additionally hold segments 211 and 221 that are those ends of the folded first and second belt sections 21 and 22 which are dangling from the first and second connecting members 231 and 232. This structure can reduce the possibility of the dog in the fitting implement 1 biting the segments 211 and 221 and hence damaging the fitting implement 1.

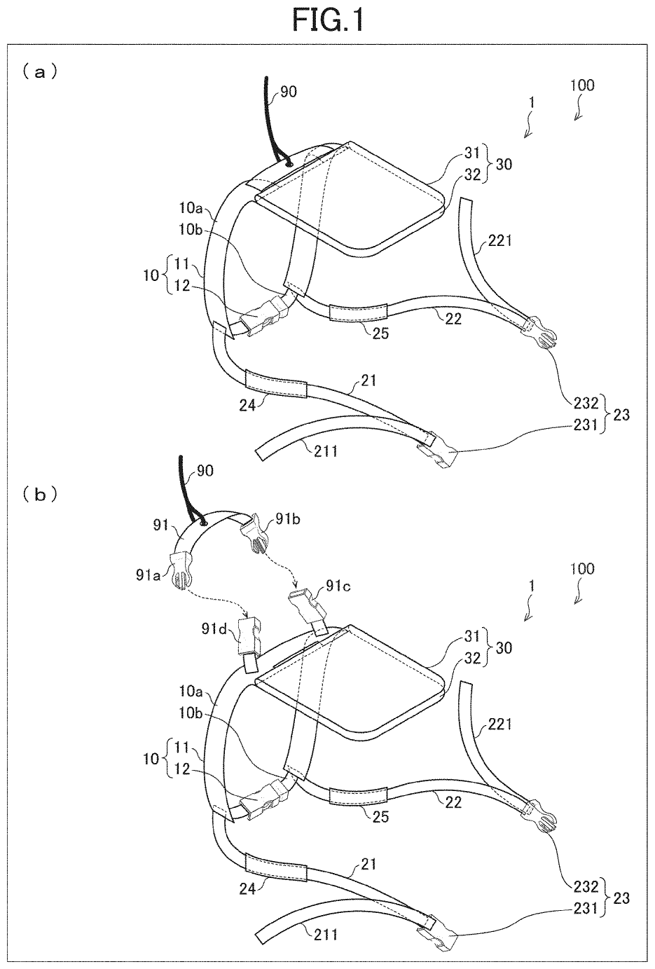

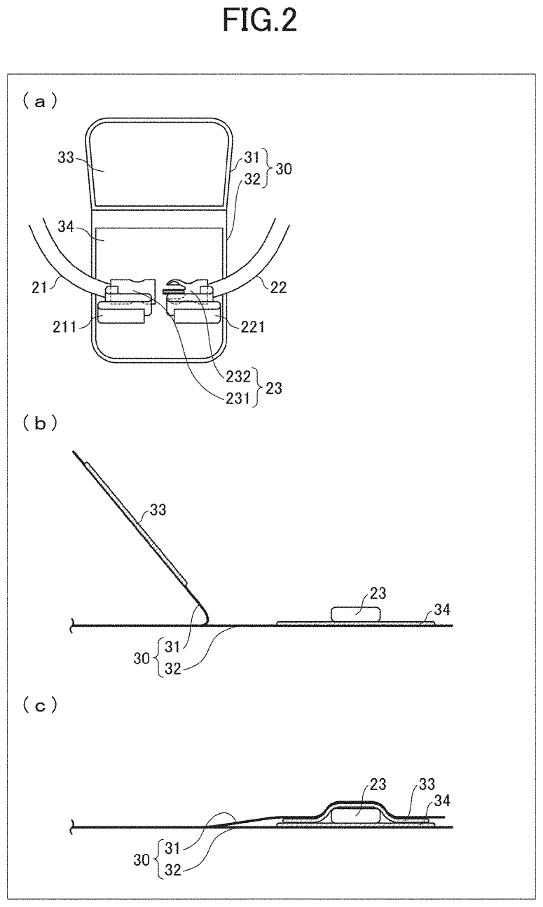

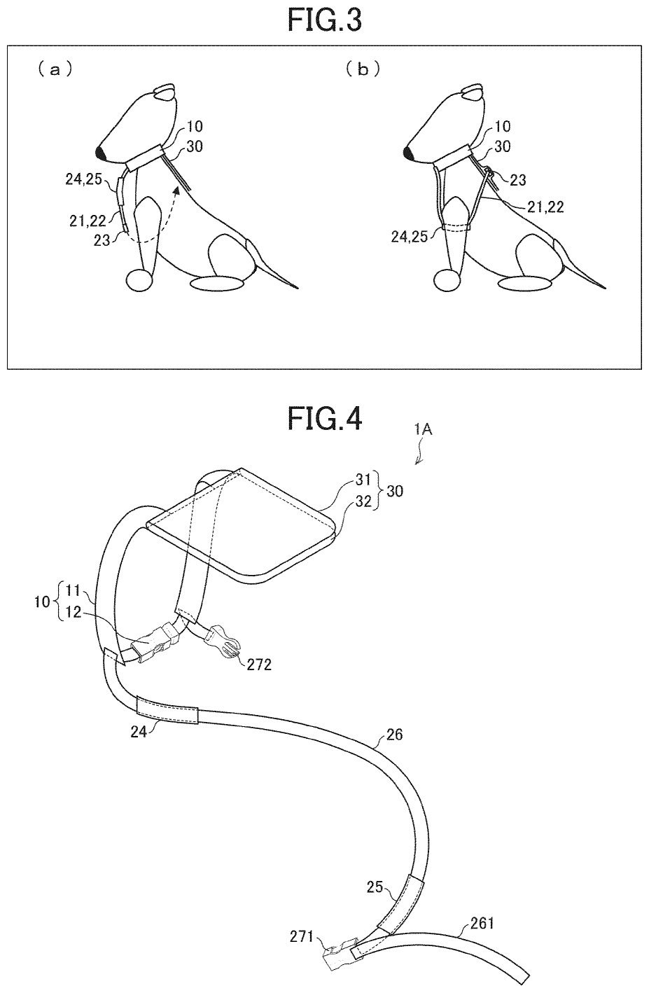

FIG. 3 is a set of illustrations of a method of fitting the fitting implement 1 to a dog, (a) of FIG. 3 showing the fitting implement 1 being fitted to a dog and (b) of FIG. 3 showing the fitting implement 1 having been fitted completely. To fit the fitting implement 1 to a dog, a user (e.g., the dog's owner or veterinarian) first of all fits the collar section 10 around the neck of the dog as shown in (a) of FIG. 2 (fitting step). Next, the user passes the first belt section 21 and the second belt section 22 under the dog's respective armpits, in such a manner that the first belt section 21 and the second belt section 22 come into contact with the dog's left and right axillae respectively (axilla contact step). The user then connects the second ends of the first belt section 21 and the second belt section 22 (those ends where the first belt section 21 and the second belt section 22 are not connected to the collar section 10) via the connecting sections 23 (connecting step). The user can fit the fitting implement 1 to the dog by these steps.

The fitting implement 1 includes: the collar section 10 fitted around the neck of an animal; and the first belt section 21 and the second belt section 22 each having a first end connected to the collar section 10 as described above. The first belt section 21 and the second belt section 22 each have a second end where there is provided a connecting section 23 to connect the first belt section 21 and the second belt section 22 together at these second ends.

Therefore, when the user wants to fit the fitting implement 1, he/she needs only to fit the collar section 10 to the dog, pass the first and second belt sections 21 and 22 under the dog's armpits, and connect the first and second belt sections 21 and 22 on the dog's back. When the first belt section 21 and the second belt section 22 are pulled toward the back of the dog due to a change in action or posture of the dog, the collar section 10 is pulled toward the front of the dog, thereby reducing the possibility of the fitting implement 1 constricting the dog's neck. The fitting implement 1 hence reduces stress on the dog both while the fitting implement 1 is being fitted to the dog and after the fitting implement 1 is completely fitted to the dog.

### Variation Example 1

FIG. 4 is a perspective view of a structure of a fitting implement 1A in accordance with a variation example of the present embodiment. The fitting implement 1 includes the first belt section 21 and the second belt section 22 in the embodiment described above. The fitting implement 1A of the present variation example may include only one belt section 26, not two belt sections. The belt section 26 has a first end connected to the collar section 10. The belt section 26 has a second end where there is provided a connecting member 271 to connect that second end to the collar section 10. The collar section 10 further includes a connecting member 272 for connection to the connecting member 271.

The belt section 26 has a sufficient length to be passed from either the left or right armpit of the dog over the back to the opposite armpit for fitting. To fit the fitting implement 1A to a dog, the user first of all fits the collar section 10 around the dog's neck in the same manner as he/she fits the fitting implement 1 (fitting step). Next, the user passes the belt section 26 under the dog's armpits, in such a manner that the belt section 26 passes over the dog's back and comes into contact with the left and right axillae (axilla contact step). The user then connects the second end of the belt section 26 to the collar section 10 (connecting step).

Since the belt section 26 is passed under the dog's armpits and over its back, this fitting implement 1A reduces stress on the dog similarly to the fitting implement 1 described above. The holder section 30 can additionally hold a segment 261 that is the end of the folded belt section 26 that is dangling from the connecting member 271 if the segment 261 is too long.

### Variation Example 2

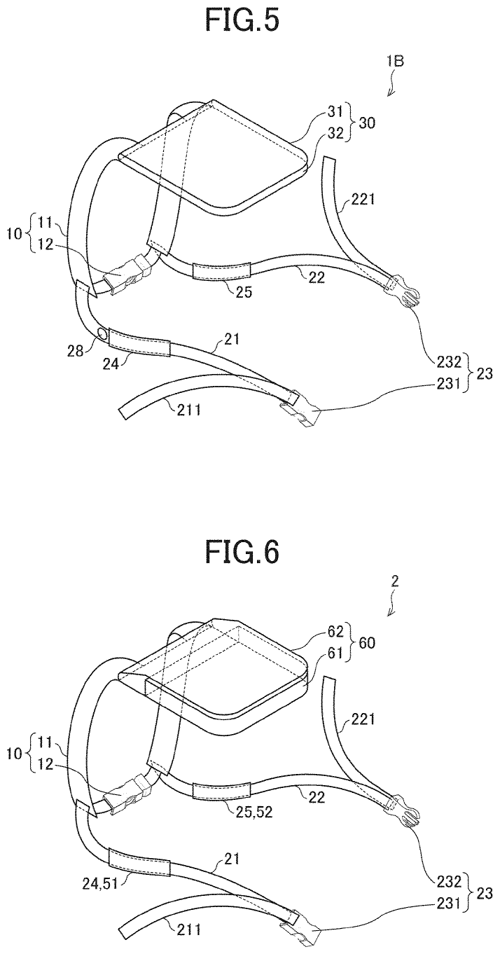

FIG. 5 is a perspective view of a structure of a fitting implement 1B in accordance with a variation example of the present embodiment other than the variation example shown in FIG. 4. The fitting implement 1B includes a pressure sensor 28 on a face that is in the vicinity of the contact section 24 of the first belt section 21 or the contact section 25 of the second belt section 22 and that comes into contact with the dog's body. The pressure sensor 28 may measure the pressure applied by the first belt section 21 to the dog's body, so that the pressure can be displayed on a display device (e.g., a display device for a personal computer or a smartphone) owned by the user. The pressure sensor 28 may alternatively be so arranged that the display device can display a message that the pressure is too strong or too weak. As a further alternative, the pressure sensor 28 may be so arranged that the user can intuitively understand the magnitude or appropriateness (e.g., too weak, appropriate, or too strong) of the fastening force by means of an indicator or color display representing the fastening force.

Any of these arrangements enables the user to adjust the length of the first belt section 21 on the basis of the pressure measured by the pressure sensor 28, so that the first belt section 21 is in contact with the dog with suitable pressure. The pressure sensor 28 is provided only on the first belt section 21 in the example shown in FIG. 5. Alternatively, there may be provided two pressure sensors 28, one on the first belt section 21 and the other on the second belt section 22. A single pressure sensor may be provided only on the second belt section 22.

### Embodiment 2

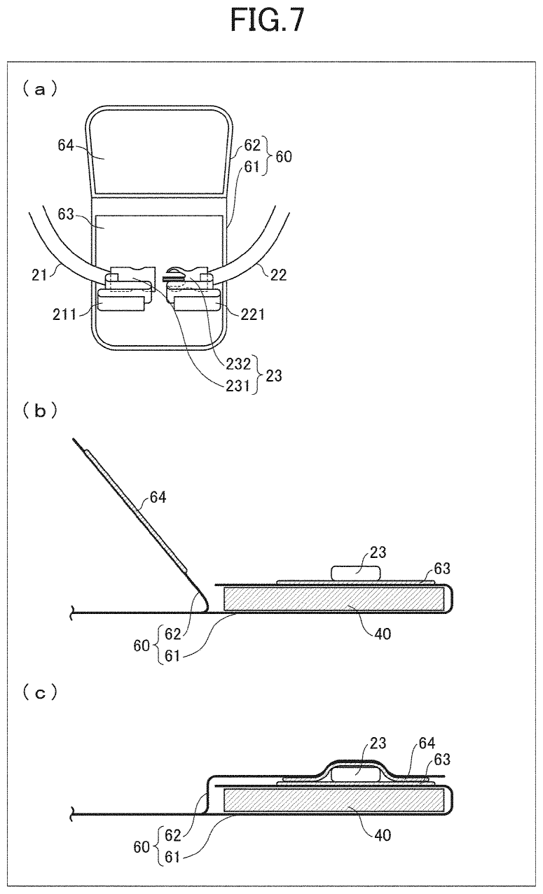

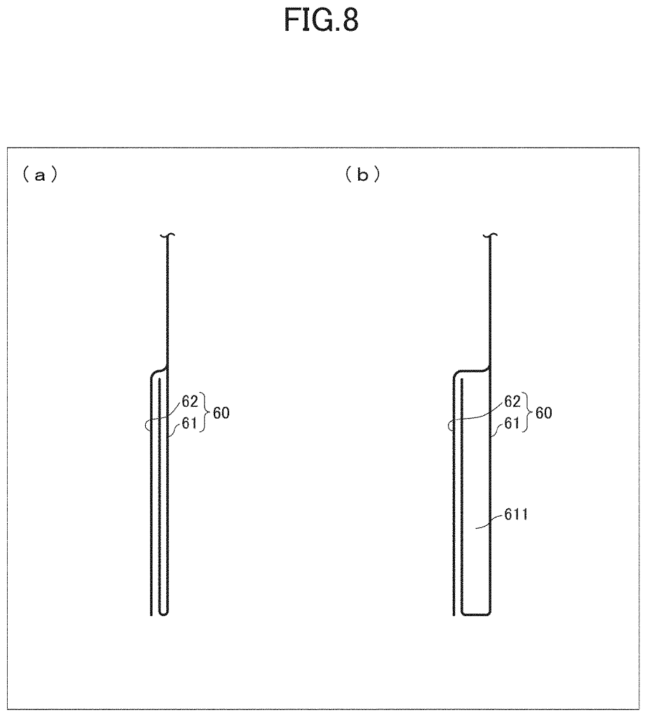

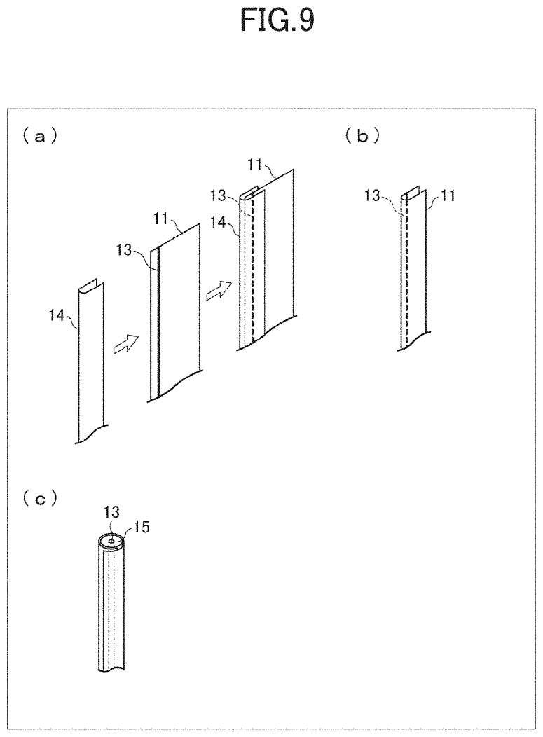

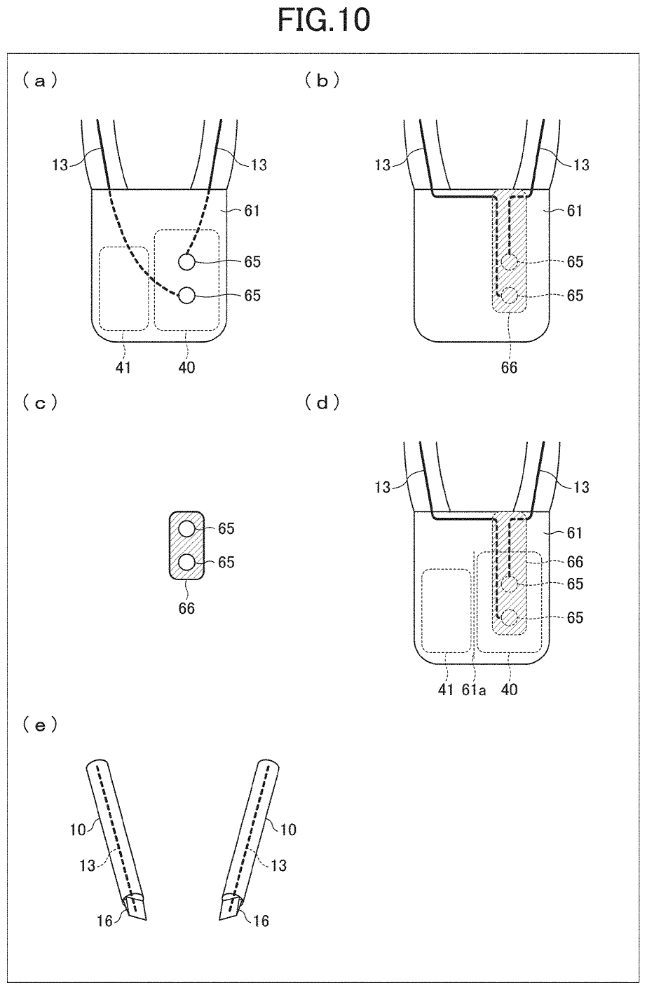

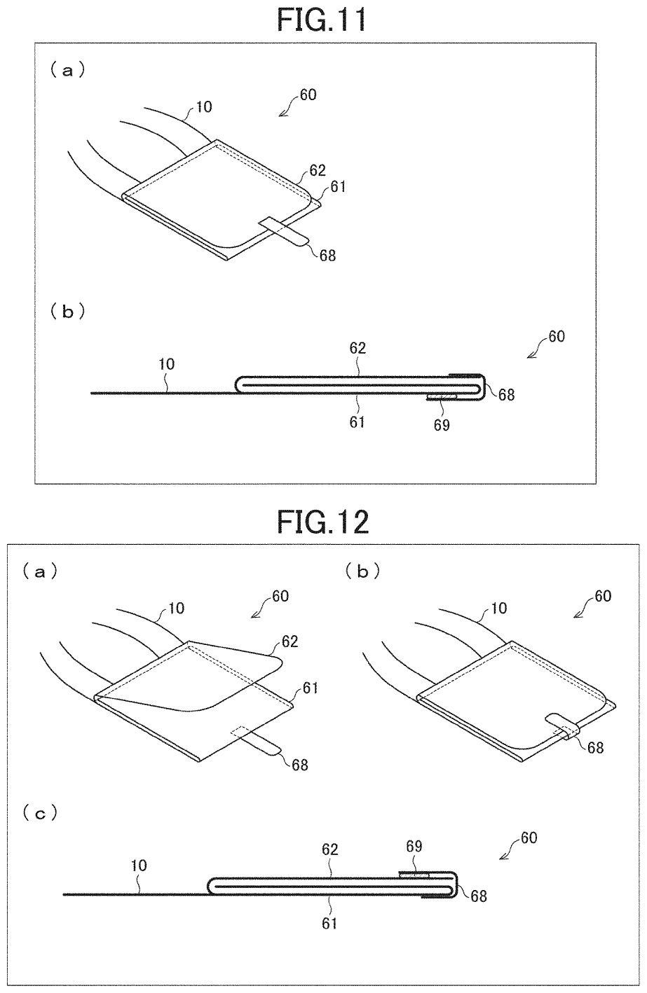

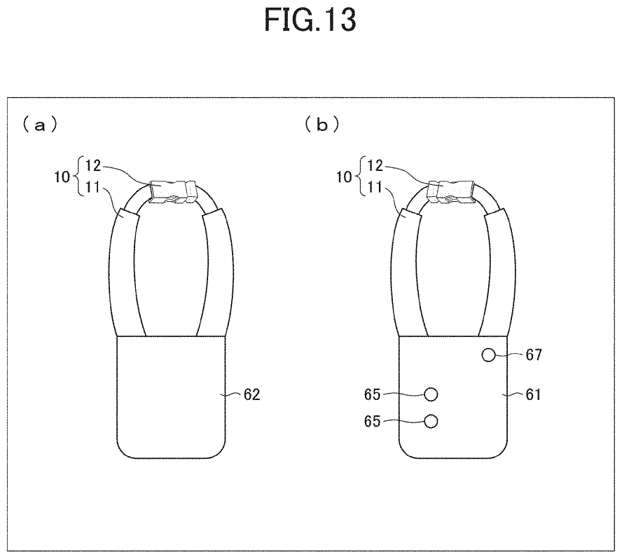

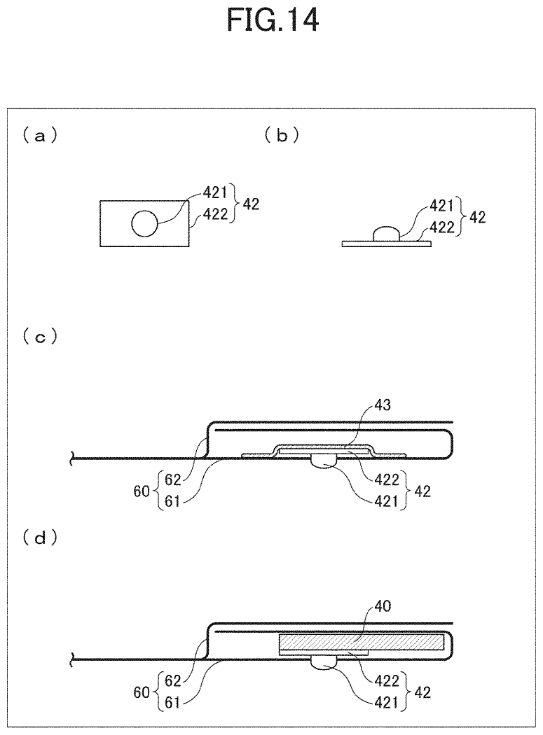

A description is now given of another embodiment of the present disclosure with reference to FIGS. 6 to 10. For convenience of description, members of the present embodiment that have the same function as members of the previous embodiment are indicated by the same reference numerals, and description thereof is omitted.

FIG. 6 is a perspective view of a structure of a fitting implement 2 in accordance with the present embodiment. The fitting implement 2 is, for example, an instrument for measuring the dog's cardiac electrical activity. The fitting implement 2 differs from the fitting implement 1 in that the fitting implement 2 does not include the holder section 30 and instead includes a measuring instrument 40, conductive wires 13, electrodes 51 and 52, and a casing 60.

The casing 60 is arranged to sit on the back of a dog when the collar section 10 is fitted to the dog, similarly to the holder section 30. Specifically, the casing 60 is disposed on a longer one of the circumferential segments of the collar section 10 delimited by the locations of the connections of the first and second belt sections 21 and 22 to the collar section 10. The casing 60 may be made of, for example, cloth such as woven fabric of chemical or natural fibers. Besides cloth, the casing 60 may also be formed of a plastic material in the shape of a rigid box or of a silicon material in the shape of a soft box or bag. The casing 60 includes a bag section 61 (first opposing section) and a cover section 62 (second opposing section). The bag section 61 is a bag-shaped member for holding the measuring instrument 40 therein. The cover section 62 is a member for covering the opening of the bag section 61. In the present embodiment, there are provided hook and loop fasteners 63 and 64, as fixing members for fixing the cover section 62 to the outside of the bag section 61, respectively on a surface of the bag section 61 facing the cover section 62 and a surface of the cover section 62 facing the bag section 61. The casing 60 houses the connecting sections 23 therein in the present embodiment.

Portion (a) of FIG. 7 is a front view of the cover section 62 of the casing 60 with the cover section 62 being open, (b) of FIG. 7 is a side view of the cover section 62 in the same condition as in (a) of FIG. 7, and (c) of FIG. 7 is a side view of the cover section 62 which is now closed.

To hold the connecting sections 23 in the casing 60, the connecting sections 23 are connected on the bag section 61 with the cover section 62 being open as shown in (a) and (b) of FIG. 7. When the cover section 62 is closed in this condition as shown in (c) of FIG. 7, the hook and loop fasteners 63 and 64 engage with each other, sandwiching the connecting sections 23 therebetween. The casing 60 can hence hold the connecting sections 23. The casing 60 may additionally hold the dangling ends of the first belt section 21 and the second belt section 22.

Portion (a) of FIG. 8 is an illustration of an exemplary shape of the bag section 61, and (b) of FIG. 8 is an illustration of an exemplary shape of the bag section 61 other than the example shown in (a) of FIG. 8. The bag section 61 may be shaped with no gore, for example, as shown in (a) of FIG. 8. The bag section 61 may alternatively be shaped including a gore 611, for example, as shown in (b) of FIG. 8.

The measuring instrument 40 is a device for measuring the dog's cardiac electrical activity. The measuring instrument 40 is connected electrically to the electrodes 51 and 52 via the conductive wires 13. The electrodes 51 and 52 are disposed in such location as to flank the dog's heart. The measuring instrument 40 detects and analyzes the electrical potential difference between the electrodes 51 and 52 to measure the dog's cardiac electrical activity.

The electrodes 51 and 52 are electrodes for measuring the dog's cardiac electrical activity. The electrodes 51 and 52 may alternatively be devices for measuring biological information other than the dog's cardiac electrical activity. Specifically, the electrodes 51 and 52 may be, for example, pieces of conductive cloth disposed on the outer circumference of the cushioning material. The electrodes 51 and 52 are provided in the contact sections 24 and 25. The contact sections 24 and 25 are brought into contact with the dog's axillae as described earlier. Therefore, the electrodes 51 and 52 are similarly brought into contact with the dog's axillae.

Conductive gel sheets may additionally be attached around the electrodes 51 and 52. The gel sheets are auxiliary members intended to increase the skin-electrode contact area for improved electrical conductivity. The attaching of the gel sheets also better maintains the contact between the electrodes 51 and 52 and the axillae even if the dog in the fitting implement 2 changes its posture.

In an axilla, the dog's body has a surface area with relatively sparse fur. Therefore, by bringing the electrodes 51 and 52 into contact with the axillae, the dog's cardiac electrical activity can be measured without having to shave the fur, apply electrically conductive gel, or perform another similarly troublesome process. The axillae are unlikely to come into contact with, for example, the floor or wall. For this reason, the electrodes 51 and 52 will remain in place, which contributes to successful normal measurement.

Portion (a) of FIG. 9 is an illustration of an exemplary method of disposing the conductive wires 13 in the collar section 10, the first belt section 21, or the second belt section 22. Each conductive wire 13 is a signal line connecting the electrode 51 or 52 to the measuring instrument 40. The conductive wires 13 run in the first belt section 21, the second belt section, and the collar section 10. In other words, the electrodes 51 and 52 are connected to the measuring instrument 40 via the conductive wires 13 running in the first or second belt section 21 or 22 and the collar section 10. The conductive wires 13 may be made of, for example, a metal, an electrically conductive thread, or an electrically conductive tape.

According to the method shown in (a) of FIG. 9, one of the conductive wires 13 is disposed near a side of the main segment 11 of the collar section 10 with respect to the width direction thereof. The conductive wire 13 is then covered with an edging member 14 that is typically a bias tape, so that the collar section 10 encloses, and does not expose, the conductive wire 13. The other conductive wires 13, running from the electrodes 51 and 52 to the collar section 10 through the first belt section 21 and the second belt section 22 respectively, are provided in a similar manner.

The edging member 14 is preferably made of a non-conductive material such as cotton, synthetic fiber, or rubber. Cloth or other material with an electromagnetic shielding property may additionally be attached or sewn to the external or internal surface of the edging member 14. The covering of the conductive wires 13 with the edging member 14 reduces both noise induced by the contact of the conductive wires 13 with an object that resides further outside such as body hair, the ground, or the floor and noise from electromagnetic waves travelling in the surroundings.

Portion (b) of FIG. 9 is an illustration of an exemplary method of disposing the conductive wire 13 in the collar section 10, the first belt section 21, or the second belt section 22 other than the example shown in (a) of FIG. 9. In the collar section 10, the cloth constituting the main segment 11 itself may be so structured as to be wrapped around the conductive wire 13 as shown in (b) of FIG. 9.

Portion (c) of FIG. 9 is an illustration of an exemplary method of disposing the conductive wire 13 in the collar section 10, the first belt section 21, or the second belt section 22 other than the examples shown in (a) and (b) of FIG. 9. The collar section 10 shown in (c) of FIG. 9 includes interfacing 15 covered with cloth, in order to maintain the collar shape. The interfacing 15 is made of, for example, rubber. In such an example, the first belt section 21 or the second belt section 22 may include the conductive wires 13 embedded in the interfacing 15.

Portion (a) of FIG. 10 is a backside view of an exemplary method of connecting the electrodes 51 and 52 to the measuring instrument 40. The bag section 61 in the example shown in (a) of FIG. 10 includes two spring hooks 65. The spring hooks 65 engage with respective spring hooks (not shown) provided on the measuring instrument 40. The spring hooks 65 are connected electrically to the electrodes 51 and 52 via the conductive wires 13 respectively. The spring hooks provided on the measuring instrument 40 function as input terminals (contacts) for electric signals to the measuring instrument 40. This engagement of the spring hooks 65 with the respective spring hooks provided on the measuring instrument 40 connects the measuring instrument 40 to the electrodes 51 and 52 and also fixes the measuring instrument 40 to the casing 60. There may be provided three or more spring hooks 65 on each of the bag section 61 and the measuring instrument 40. The spring hooks 65 are provided outside the bag section 61 in the example shown in (a) of FIG. 10, but are not necessarily provided outside the bag section 61.

In the example shown in (a) of FIG. 10, the spring hooks 65 are provided off the center of the bag section 61, and the bag section 61 is sufficiently larger in size than the measuring instrument 40. The bag section 61 is therefore capable of housing a battery 41, as well as the measuring instrument 40, to power the measuring instrument 40. Needless to say, the measuring instrument 40 is connected electrically to the battery 41 (connection not shown).

Portion (b) of FIG. 10 is a backside view of an exemplary method of connecting the electrodes 51 and 52 to the measuring instrument 40 other than the example shown in (a) of FIG. 10. The measuring instrument 40 and the battery 41 are omitted in (b) of FIG. 10. The spring hooks 65 are provided on the bag section 61 in the example shown in (a) of FIG. 10. In contrast, in the example shown in (b) of FIG. 10, the casing 60 includes a strap member 66 where the spring hooks 65 are provided.

The strap member 66 is a strap-shaped member fixed to the casing 60 only at an end thereof. The other end of the strap member 66 is not fixed. Therefore, the whole strap member 66, including the spring hooks 65, can be taken out of the bag section 61 in the example shown in (b) of FIG. 10. The measuring instrument 40 can hence be connected to the spring hooks 65 before being stowed into the bag section 61. The measuring instrument 40 can be housed in the casing 60 more easily in the example shown in (b) of FIG. 10 than in the example shown in (a) of FIG. 10.

Portion (c) of FIG. 10 is an illustration of another example of the strap member 66. The strap member 66 has an end fixed to the casing 60 in the example shown in (b) of FIG. 10. Alternatively, the strap member 66 may have none of the ends thereof fixed to the casing 60. In such cases, the strap member 66 needs only to provide an area where the two spring hooks 65 are disposed and may therefore have a reduced area as shown in (c) of FIG. 10.

The relative positions of the casing 60 and the measuring instrument 40 are variable in the examples shown in (b) and (c) of FIG. 10. Acceleration may therefore be not detected in a suitable manner, for example, if the measuring instrument 40 further includes an acceleration sensor to measure changes in position of the dog. In such cases, the example shown in (a) of FIG. 10 may be used as a preferred example.

Portion (d) of FIG. 10 is an illustration of a variation example of the exemplary method of connecting the electrodes 51 and 52 to the measuring instrument 40 shown in (b) of FIG. 10. The example shown in (d) of FIG. 10 differs from the example shown in (b) of FIG. 10 in that the bag section 61 in the former includes a partition 61a.

The partition 61a is formed by, for example, sewing, to the inner surface of the bag section 61, a piece of cloth other than the piece of cloth constituting the bag section 61. The partition 61a divides the interior of the bag section 61 into two areas. The measuring instrument 40 and the battery 41 are housed in different areas.

This structure does not allow the measuring instrument 40 to move inside the bag section 61 as much as does the example shown in (b) of FIG. 10, thereby reducing displacement of the measuring instrument 40. The structure can hence improve precision in the detection of acceleration when the measuring instrument 40 includes an acceleration sensor. The partition 61a may alternatively be formed by sewing or attaching the cloth on the front of the bag section 61 to the cloth on the back of the bag section 61.

Portion (e) of FIG. 10 is an illustration of another exemplary method of connecting the electrodes 51 and 52 to the measuring instrument 40. A connector 16 is provided at each end of the collar section 10 to connect the measuring instrument 40 electrically to the electrodes 51 and 52 in the example shown in (e) of FIG. 10. The connector 16 is a connection terminal provided on an exposed part of the conductive wire 13 on an end of the collar section 10. The connector 16 is connected to a connection terminal (not shown) provided on a substrate for the conductive wires 13 and the measuring instrument 40. This is another method of connecting the electrodes 51 and 52 to the measuring instrument 40.

The fitting implement 2 includes the electrodes 51 and 52 in locations where the fitting implement 2 comes into contact with the dog's axillae, as described above. The fitting implement 2 further includes: the measuring instrument 40 for detecting and analyzing the electrical potential difference between the electrodes 51 and 52 to measure the cardiac electrical activity of a dog (a subject to be examined); the conductive wires 13 serving as signal lines connecting the electrode 51 and 52 to the measuring instrument 40; and the casing 60 for housing the measuring instrument 40 and the battery 41. Therefore, the fitting implement 2, when fitted to a dog, enables measurement of the dog's cardiac electrical activity. The fitting implement 2 may include a communications unit for externally transmitting information representing the electrical potential difference between the electrodes 51 and 52, instead of including the measuring instrument 40, in which case an external device receiving the information can measure the dog's cardiac electrical activity.

### Variation Example

A description is now given of a variation example of the casing 60. The casing 60 in the following variation example differs from the fitting implement 2 of the embodiments described above in that the former includes no hook and loop fasteners 63 and 64 for fixing the closed cover section 62.

Portion (a) of FIG. 11 is a perspective view of the casing 60 with the cover section 62 including a fixing member 68, and (b) of FIG. 11 is a cross-sectional view of the casing 60 shown in (a) of FIG. 11 with the cover section 62 being closed, as viewed from a side of the casing 60. The measuring instrument 40 and the battery 41 are omitted in (a) and (b) of FIG. 11.

In the casing 60 shown in (a) and (b) of FIG. 11, the fixing member 68 is a strap-shaped member fixed to the cover section 62 at an end thereof. A hook and loop fastener 69 is provided at the other end of the fixing member 68 and on a surface of the bag section 61 opposite the cover section 62 (on the back of the bag section 61). The closed cover section 62 can be fixed by passing a fixing member 68 over the back of the bag section 61 and fixing the fixing member 35 with the hook and loop fastener 69 as shown in (b) of FIG. 11. A button, a hook, or a press stud, to name a few examples, may be provided on the fixing member 68 and on the back of the bag section 61, replacing the hook and loop fastener 69.

Portion (a) of FIG. 12 is a perspective view of the casing 60 with the bag section 61 including the fixing member 68, (b) of FIG. 12 is a perspective view of the casing 60 shown in (a) of FIG. 12 with the cover section 62 being closed, and (c) of FIG. 12 is a cross-sectional view of the casing 60 in the same condition as in (b) of FIG. 12, as viewed from a side of the casing 60. The fixing member 68 is a strap-shaped member fixed to the bag section 61 at an end thereof as shown in (a) of FIG. 12. A hook and loop fastener is provided at the other end of the fixing member 68 and on a surface of the cover section 62 opposite the bag section 61 (on the front of the cover section 62). The cover section 62 can be closed by passing the fixing member 68 over the front of the cover section 62 and fixing the fixing member 68 with the hook and loop fastener as shown in (b) of FIG. 12. A button, a hook, or a press stud, to name a few examples, may be provided on the fixing member 68 and on the front of the cover section 62, replacing the hook and loop fastener 69.

Embodiment 1 was described as the fitting implement 1 not necessarily including the second belt section 22. On the other hand, the fitting implement 2 of the present embodiment needs to connect the measuring instrument 40 and the electrodes 51 and 52. If the fitting implement 2 includes no second belt section 22, one of the electrodes 51 and 52 requires a conductive wire with an additional length to be connected to the measuring instrument, or electrical connections need to be established by the connecting sections 23. For these reasons, the fitting implement 2 has a simpler structure if the fitting implement 2 includes the first belt section 21 and the second belt section 22.

### Embodiment 3

A description is now given of another embodiment of the present disclosure with reference to FIGS. 13 and 14.

FIG. 13 is a set of illustrations of a structure of a portion of a fitting implement 3 in accordance with the present embodiment, (a) of FIG. 13 being a front view and (b) of FIG. 13 being a backside view. The fitting implement 3 has substantially the same structure as the fitting implement 2. The first belt section 21 and the second belt section 22 are omitted in FIG. 13 for this reason.

Referring to FIG. 13, the fitting implement 3 has a hole 67 on the back of the casing 60, that is, on the surface that faces the dog. The fitting implement 3 includes a temperature sensor 42. The measuring instrument 40 has a function of measuring the body surface temperature of a dog. The temperature sensor 42 is a body surface temperature sensor that is brought into contact with the dog's body via the hole 67 to measure the dog's body surface temperature.

Portion (a) of FIG. 14 is a bottom view of the temperature sensor 42 showing its shape, and (b) of FIG. 14 is a side view of the temperature sensor 42 showing its shape. The temperature sensor 42 includes a sensor unit 421 for detecting the dog's body surface temperature and a stopper 422 for preventing the temperature sensor 42 from falling through the hole 67 as shown in (a) and (b) of FIG. 14. The stopper 422 is a platelike member and has a larger diameter than does the hole 67. The stopper 422 is caught by the rim of the hole 67, thereby preventing the temperature sensor 42 from falling through the hole 67.

Portion (c) of FIG. 14 is an illustration of an exemplary method of fixing the temperature sensor 42 in the location of the hole 67. There is provided a press member 43 inside the bag section 61 in the example shown in (c) of FIG. 14. The press member 43 exerts a force on the temperature sensor 42 in the direction of pushing the temperature sensor 42 out of the hole 67. The press member 43 is a strap-shaped member formed so as to cover the hole 67 inside the bag section 61. The press member 43 is made of an elastic material such as rubber. To install the temperature sensor 42 in the bag section 61, the press member 43 is displaced to expose the sensor unit 421 in the hole 67 and thereafter returned to the original location. The temperature sensor 42 can be removed from the bag section 61 by the same procedures as when the temperature sensor 42 is installed, but performed in reverse order.

Portion (d) of FIG. 14 is an illustration of an exemplary method of fixing the temperature sensor 42 in the location of the hole 67 other than the example shown in (c) of FIG. 14. The measuring instrument 40 is disposed on a side of the temperature sensor 42 opposite the side thereof that comes into contact with the dog's body in the example shown in (d) of FIG. 14. Instead of the measuring instrument 40, the battery 41 may be disposed on that opposite side. Another member may be used as described here to exert a force in the direction of pushing the temperature sensor 42 out of the hole 67.

The methods shown in (c) and (d) of FIG. 14 can fix the temperature sensor 42 in the location of the hole 67 without having to sewing the temperature sensor 42 to the bag section 61. Therefore, the temperature sensor 42 can be readily removed from the casing 60 when necessary. The casing 60, which directly touches the dog's body, can be washed.

### CROSS-REFERENCE TO RELATED APPLICATIONS

The present application claims priority to Japanese Patent Application, Tokugan, No. 2017-153661 filed on Aug. 8, 2017, which is incorporated herein by reference in its entirety.

The present disclosure is not limited to the description of the embodiments above and may be altered within the scope of the claims. Embodiments based on a proper combination of technical means disclosed in different embodiments are encompassed in the technical scope of the present disclosure. Furthermore, a new technological feature can be created by combining different technological means disclosed in the embodiments.

1. A fitting implement to be worn by an animal, the fitting implement comprising:
a collar section to be fitted around a neck of the animal; and
a first belt section and a second belt section each having an end connected to the collar section, wherein
the first and second belt sections each include, at another end thereof, a connecting section configured to connect the other ends together.

2. The fitting implement according to claim 1, wherein the collar section includes a first opposing section and a second opposing section configured to sandwich either one or both of the first and second belt sections.

3. The fitting implement according to claim 2, wherein
the collar section including two circumferential segments delimited by locations of the connections of the first and second belt sections to the collar section, the first opposing section is a first piece of cloth either constituting a part of a longer one of the circumferential segments or attached to that longer circumferential segment,
the second opposing section is a second piece of cloth attached to a part of the collar section or to the first piece of cloth, and
the first and second pieces of cloth each include a hook and loop fastener on an opposing face thereof.

4. The fitting implement according to claim 1, wherein
either the first or second belt section includes an electrode in a portion thereof where that first or second belt section comes into contact with an axilla of the animal, and
the electrode is connected via a conductive wire running through the first or second belt section and the collar section to a measuring instrument configured to take a measurement on the animal for biological information,
the collar section including two circumferential segments delimited by locations of the connections of the first and second belt sections to the collar section, the fitting implement further comprising:
a bag section on a longer one of the circumferential segments, the bag section being configured to hold the measuring instrument therein;
a cover section configured to cover an opening of the bag section; and
a fixing member configured to fix the cover section to an exterior of the bag section.

5. A fitting implement to be worn by an animal, the fitting implement comprising:
a collar section to be fitted around a neck of the animal; and
a belt section having an end connected to the collar section, wherein
the belt section includes, at another end thereof, a connecting section configured to connect the other end to the collar section, and
the belt section is fitted by being passed under either one of left and right armpits of the animal, over a back of the animal, and then under the opposite armpit.

6. A method of fitting the fitting implement according to claim 1 to the animal, the method comprising:
the fitting step of fitting the collar section around the neck of the animal;
the axilla contact step of passing the first and second belt sections under respective armpits of the animal in such a manner that the first and second belt sections come into contact with respective left and right axillae of the animal; and
the connecting step of connecting together the other ends of the first and second belt sections.

7. (canceled)
